(19) United States
(12) Patent Application Publication
(10) Pub. No.: US 2010/0327665 A1
(43) Pub. Date: Dec. 30, 2010

(54) Ready 2 go

(75) Inventor: Anthony Vidana, Kailua Kona, HI (US)

Correspondence Address: Anthony D Vidana Jr., P.O. Box 2397, Kailua Kona, HI, 96745, US

(73) Assignee: Anthony David Vidana, JR., Kailua Kona, HI (US)

(21) Appl. No.: 12/383,793

(22) Filed: Jun. 27, 2009

(51) Int. Cl. H02J 7/00

(52) U.S. Cl. 307/150

(57) ABSTRACT

The Ready2Go is a power storage and redisbursement system. The operation of the Ready2Go is that of a battery and inverter system¹. That which is new and unique is the exoskeleton/cart². The improvement of an existing apparatus is the power vs. mobility. The power being that it supplies a minimum of 2,400-watts at 120 volts with a minimum of 240 amp hours (battery storage capacity), whilst the unit is mobile, i.e., wheeled, and is under 300 pounds in total weight, and has a footprint no bigger than 24×24 inches. The Ready2Go is non-mechanical save for the wheels³, which are a simple two-wheeled axle system. The electrical components of the machine are covered under separate applications. ¹Section 608.01(b) under section B content paragraph that reads, “The abstract should not refer to purported merits or speculative applications of the invention and should not compare the invention with the prior art.” If I am interpreting this section incorrectly, please advise me in a timely manner.²The cart itself is pending a design patent application thereof is No. 29/314,396.³Section 608.01(b) under section B content paragraph that reads, “The abstract should not refer to purported merits or speculative applications of the invention and should not compare the invention with the prior art.” If I am interpreting this section incorrectly, please advise me in a timely manner.

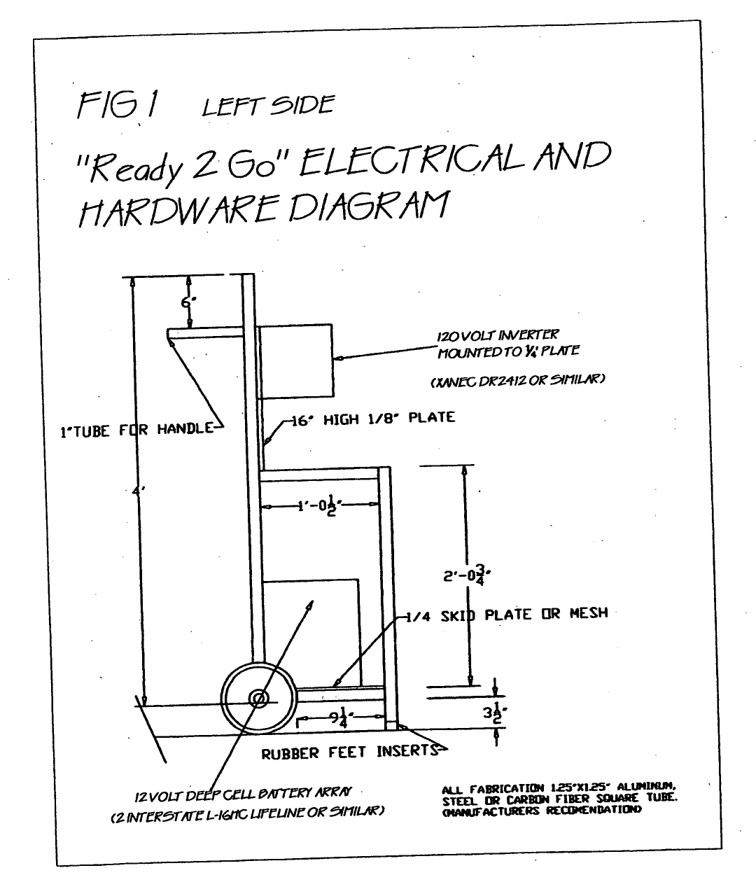

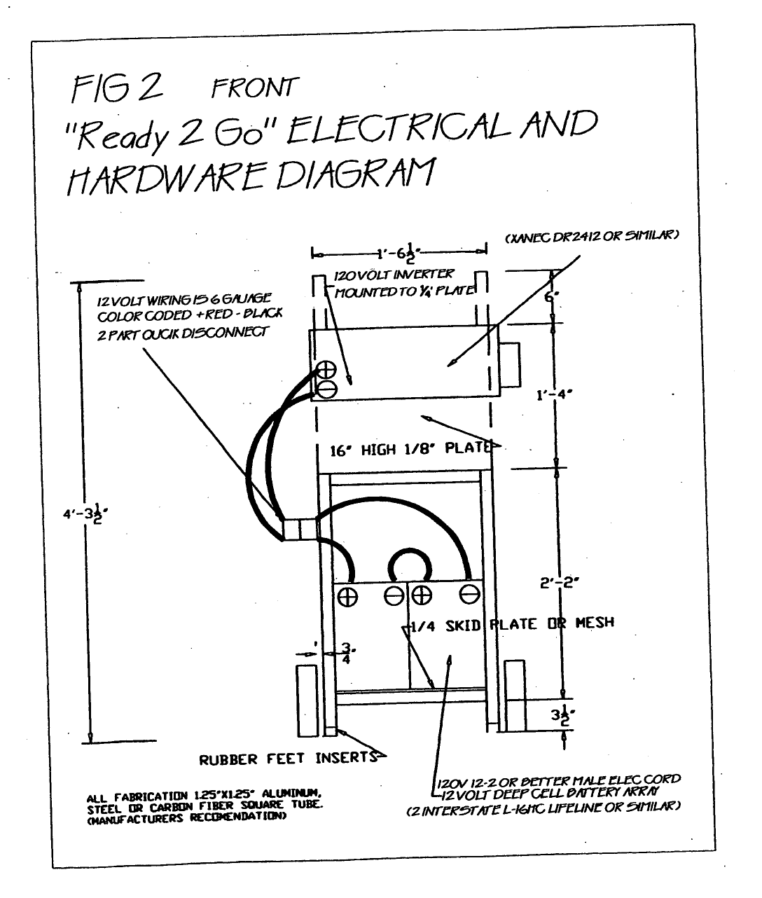

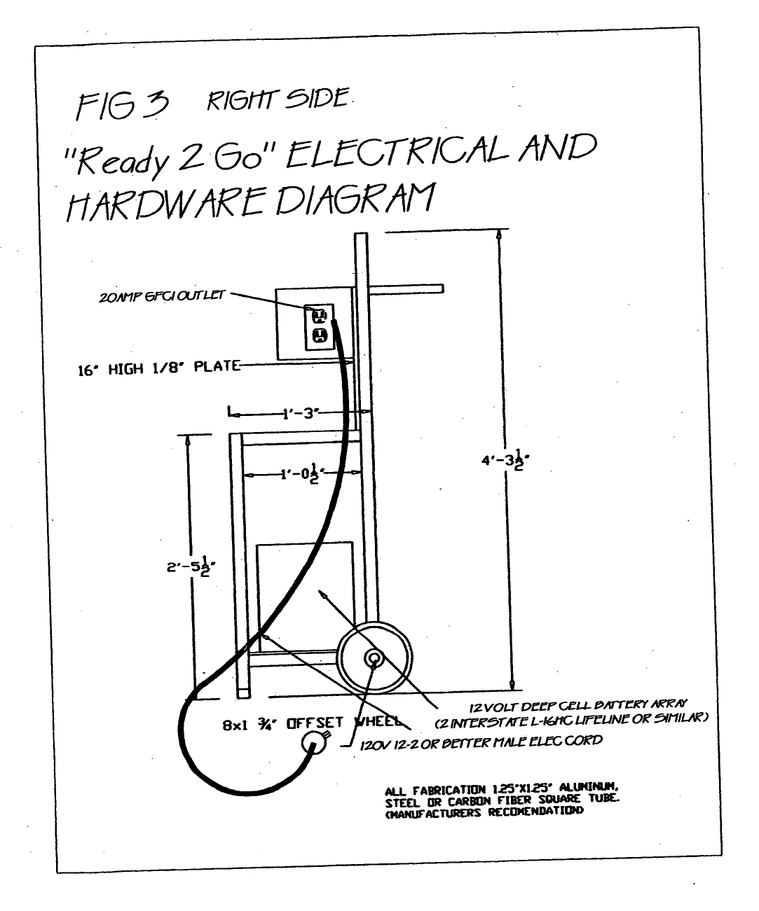

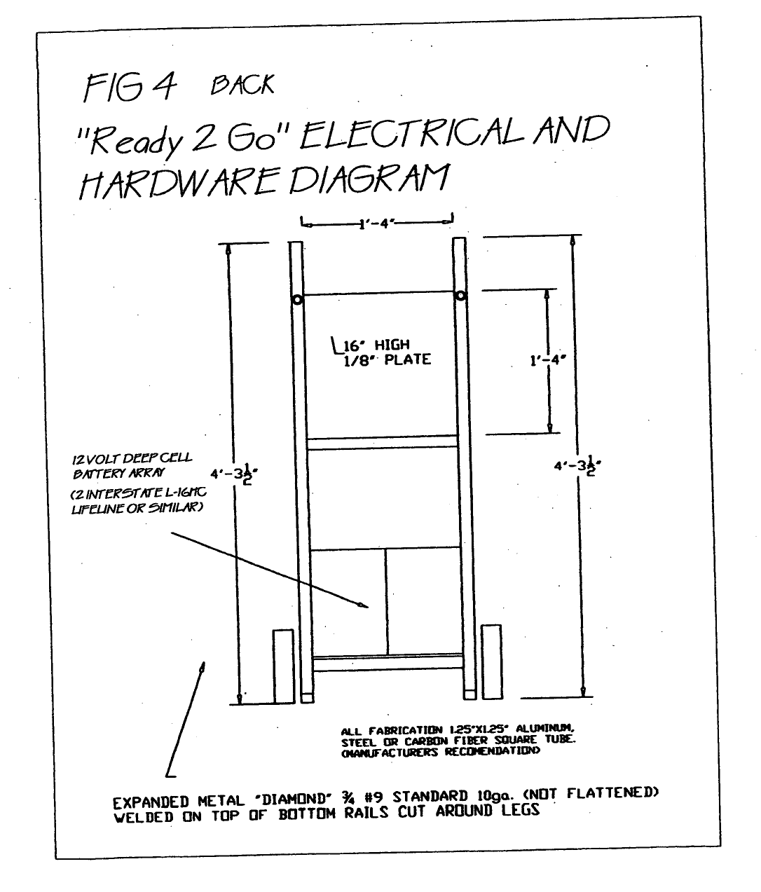

### CROSS-REFERENCE TO RELATED APPLICATIONS

Any cross reference to other applications would be made for 6 or 12 volt deep cycle gel cell batteries and/or a 12 volt to 120 volt DC to AC Inverter (if necessary.) However I have documentation that these applications have been used by the public for over 50 years (for example the original pacemakers used a similar system) so a cross check my not be warranted. The cart however is completely new and is currently patent pending under a Design patent in concert with this Utility patent application. The Provisional patent application for the entire Ready2Go is Provisional patent application No. 61/072,417 Confirmation number: 2564 dated Mar. 31, 2008

I am calling the Ready2Go an electric generator. I am doing so simply because a “stand alone, plug and play, mobile, battery and inverter system” is simply too long to say, and for some too hard to understand. I have seen other devices similar to the Ready2Go called “solar generators” which in most cases are a misnomer just as ‘electric generator’ is.) The reason that this is a misnomer is that in order to call the unit a “solar generator” it would require a solar panel system, which in most cases is a separate extra. The Ready2Go, on its own does not include solar panels in the initial configuration.

The Ready2Go has three major components: a battery charger/inverter, two deep cycle gel cell batteries, and a custom designed wheeled cart. The cart is designed to optimize the use of these two components while utilizing as small of a footprint as possible and that is also mobile. The reason that I stray from calling the Ready2Go a “solar generator” is because the initial set up for the Ready2Go is to charge the batteries through the inverter/charger using standard 120-volt alternating current (AC.) However, both the Ready2Go and the upgraded version, the Ready4Go, can be adapted to be charged with solar or other direct current (DC) alternative energy systems.

### STATEMENT REGARDING FEDERALLY SPONSORED RESEARCH OR DEVELOPMENT

Currently I am not applying for Federally Sponsored Research or Development but will be at a later date

### BACKGROUND OF THE INVENTION

Because I am a builder who has promoted green building for as long as I have been in business (roughly 26 years) and because I have built homes off the grid in Hawaii for the last 18 years I found it necessary to create the Ready2Go. First of all, for philosophical reasons, I felt that if I was going to be building homes that are powered by the sun or other alternative energy systems then I would be hypocritical to do so using a gas powered generator or grid power to construct them. The reason is that Hawaii gets almost 98% of their grid power from fossil fuels. The local electric utility company, Hawaii Electric Company, will say that those numbers are actually lower but they are taking ‘artistic license’ to do so. So by using grid power or a gas powered generator I am essentially using the same fuels to build a home, for my clients who are trying to get away from those fuels, mostly for philosophical reasons. Additionally, as a builder I didn't like the sound pollution that a gas powered generator makes, the drain on my bottom line that the cost of fueling the generators require, and, equally important, the amount of time it takes to go by the gas station and fill the gas cans to fuel the generators almost on a daily basis. Proper charging and use of the Ready2Go can eliminate all those ills.

### BRIEF SUMMARY OF THE INVENTION

The Ready2Go is a stand-alone, plug and play, mobile, electric backup power system.

The Ready2Go is a power storage and redisbursement system. It is not a power generator. It can be charged with any 120-volt standard outlet, generator, and/or 12-volt generating devices, such as solar panels, wind power or hydro systems. It utilizes off-the-shelf inverters and battery systems available on the market today. What makes it unique is the amount of power that it can store, combined with the ease of mobility and its relatively small storage footprint, (approximately 24″×24″). The combination of all three of these features is what makes this system unique. Because of the way this system is engineered, one person can move it from place to place easily and it can provide a substantial amount of power in emergency, utility or recreational situations.

### DESCRIPTION OF THE FIGURE OF THE DRAWING, FEATURE DESCRIPTION, A SINGLE CLAIM AND DRAWINGS OR PHOTOGRAPHS

Submitted are the structural/electrical integrated configuration and design plans for the Ready2Go as shown. Please see attached drawings and photographs. Photographs (images 1-3) are submitted in lieu of perspective (3d rendering) drawings. The views of the drawings are indicated on the drawing page(s). I have also included an electrical/mechanical drawing because: “While utility and design patents afford legally separate protection, the utility and ornamentality of an article are not easily separable. Articles of manufacture may possess both functional and ornamental characteristics” (from the USPO website.)

### DETAILED DESCRIPTION OF THE INVENTION

(I try to explain all parts in layman's terms, if more technical data is required please let me know)

The batteries: I use only the best gel cell deep cycle batteries. Deep cycle means that these batteries are designed to fully charge and then run for long periods of time. This is opposed to a start up battery, or car battery, the kind that the automobile industry uses for your car, which has only enough power to start your vehicle but not to run it.

Gel cell batteries are sealed and contain a gel as opposed to a liquid. Most batteries are liquid based. This liquid is an acid that can both spill and put off toxic and/or flammable gases. Gel cell batteries, on the other hand, are completely sealed, require no maintenance, and the liquid material inside them has been turned into a gel form. This makes them safer to use so that the batteries can be moved without the problem of spilling dangerous acid or leaking dangerous gases.

The cart: In both the Ready2Go and the Ready4Go the entire configuration is mounted on a custom designed, mobile, durable metal frame that serves to both mount the inverter and provide an exoskeleton for the PVC battery housing. The frame will also be offered in a Carbon Fiber model to reduce weight but at significant additional cost due to the cost of carbon fiber production.

The inverters: Most off-the-shelf inverters that one would use to power a house convert power from a DC source (DC meaning a Direct Current, in this case batteries) into AC power (AC meaning Alternating Current, or what most people would know as house current or ‘grid power’). This is where all inverters are the same including the small ones you can find at retail stores for under $100.00 in the auto parts section. Where those inverters differ from the type I use is that the small inverters only have the capacity to convert a small amount of DC power to AC power and what that means is that they allow you to use the power that your standard car battery distributes and turn it into power that you may be able to use for things such as laptops, radios or lights for a small amount of time. The inverters I use differ in that they are designed to allow more power to pass through them which makes them more practical for a home builder or for backup power in that they can actually handle enough power to operate small, hand power tools such as skill-saws, pancake compressors, drills and chop-saws for example. This also means that the Ready2Go can supply power to one or two appliances, such as a standard or small refrigerator for a short period of time . . . usually a few days, where those smaller inverters and even other stand-alone power systems not do so sufficiently. Most of these other products only support batteries that are rated at 100 amp hours. In a practical sense what that means is that under a constant load three drills can be drilling at constant load for only about 30 minutes. The good news is that most people wouldn't be drilling with three drills non-stop for 30 minutes. But it still wouldn't provide a small crew of carpenters, for example enough power to operate skill saws, compressor and a chop saw for an entire day. In the systems I design it can produce three times the amp hours in what translates to a crew of carpenters using the system for two to four days without needing to be recharged.

The system comes with engendered wiring and a quick disconnect for the battery cables that run from the inverter to the batteries. All electrical components of the Ready2Go are underwriters laboratory tested and approved including the cables.

1. I claim the design and function for the Ready2Go as shown and specified.
